(19) United States
(12) Patent Application Publication
(10) Pub. No.: US 2014/0229264 A1
(43) Pub. Date: Aug. 14, 2014

(54) LOYALTY POINT COLLECTION AND DISTRIBUTION SOCIAL NETWORK SYSTEM

(71) Applicant: Michael Ross, New York, NY (US)

(72) Inventor: Michael Ross, New York, NY (US)

(21) Appl. No.: 13/765,112

(22) Filed: Feb. 12, 2013

(51) Int. Cl. G06Q 50/00

(52) U.S. Cl. CPC G06Q 50/01; G06Q 30/0226
USPC 705/14.27

(57) ABSTRACT

A method and system of collecting loyalty points and distributing them in a social network includes forming at least one social network of an individual and one or more other network individuals; identifying the individual on the mobile communications device of the individual during a purchase at the at least one POS (point of sale) venue; determining the number of loyalty points earned by the individual at the POS venue from the purchase at the at least one POS venue; inputting the number of loyalty points earned by the individual at the POS venue into a social network server; associating the earned loyalty points from the POS venue with a social network account of the individual; and splitting up the earned loyalty points between the individual's social network account and social network accounts of the one or more other network individuals within the social network.

### TECHNICAL FIELD OF THE INVENTION

The present invention relates generally to a loyalty point collection and distribution social network system, and more particularly, to a system and method for earning loyalty points and sharing or allocating them among established social networks.

### BACKGROUND OF THE INVENTION

In an increasingly competitive marketplace, the ability to retain individuals is a significant concern for many businesses. Usually, retaining individuals is less expensive than attracting new individuals, and developing individual loyalty is an important step in that retention effort. To address the challenge of retaining individuals and developing individual loyalty, various loyalty systems and products have been developed to help businesses increase individual loyalty. Providers of services and/or products offer deals to potential or current individuals to entice them to make purchases. A deal is an offer to sell a product or service to a individual, oftentimes including a particular benefit available to individuals who buy the product or service through the deal.

A social network service provides an online platform that allows users to build a network of relationships with other users who share common interests. The popularity of social network services has grown exponentially in recent years. Most social network services provide users with the ability to create a personal profile and to upload or generate content that can be shared with other users. As social network services continue to evolve, individuals continue to use these services for sharing information with other users, and businesses have begun to use these services to disseminate information about their products and services. Improvements to social network services that allow users to share information with other users in new and interesting will be required to help differentiate social network services d to attract users.

### SUMMARY OF THE INVENTION

According to the present invention, a loyalty point collection and distribution social network system includes a social network server on which at least one social network of an individual and one or more other network individuals is formed. A means for identifying the individual during a purchase at at least one POS (point of sale) venue is provided. A merchant loyalty application is provided to determine the number of loyalty points earned by the individual at the POS venue from the purchase at the at least one POS venue. A system is provided for inputting the number of loyalty points earned by the individual at the POS venue into a social network server. The social network server associates the earned loyalty points from the POS venue with a social network account of the individual and splits up or allocates the earned loyalty points between the individual's social network account and social network accounts of the one or more other network individuals within the social network.

Also according to the present invention, a method of collecting loyalty points and distributing them in a social network includes: forming at least one social network of an individual and one or more other network individuals; identifying the individual during a purchase at the at least one POS (point of sale) venue; determining the number of loyalty points earned by the individual at the POS venue from the purchase at the at least one POS venue; inputting the number of loyalty points earned by the individual at the POS venue into a social network server; associating the earned loyalty points from the POS venue with a social network account of the individual; and allocating the earned loyalty points between the individual's social network account and social network accounts of the one or more other network individuals within the social network.

### BRIEF DESCRIPTION OF THE DRAWINGS

The structure, operation, and advantages of the present invention will become further apparent upon consideration of the following description taken in conjunction with the accompanying figures (FIGS.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 is a schematic of loyalty point collection and distribution social network system, in accordance with the present invention.

FIG. 2 is a schematic of a social network, in accordance with the present invention.

FIG. 3 is a flow chart of the process by which the loyalty point collection and distribution social network system 10 coordinates the interrelationship between the individual's social and the point of sale venues, in accordance with the present invention.

FIG. 4 is a flow chart of creating a social network account with the loyalty point collection and distribution social network system, in accordance with the present invention.

FIG. 5 is a flow chart of a variety of ways that a purchase may be completed, in accordance with the present invention.

FIG. 6 is a flow chart of the steps by which the individual utilizes the loyalty points, in accordance with the present invention.

FIG. 7 is a flow chart showing the operation of the social network server, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

In an increasingly competitive marketplace, the ability to retain individuals is a significant concern for many businesses. Usually, retaining individuals is less expensive than attracting new individuals, and developing individual loyalty is an important step in that retention effort. To address the challenge of attracting new individuals and retaining existing individuals, incentive rewards programs are becoming increasingly popular amongst businesses. Various loyalty systems and products have been developed to help businesses increase individual loyalty.

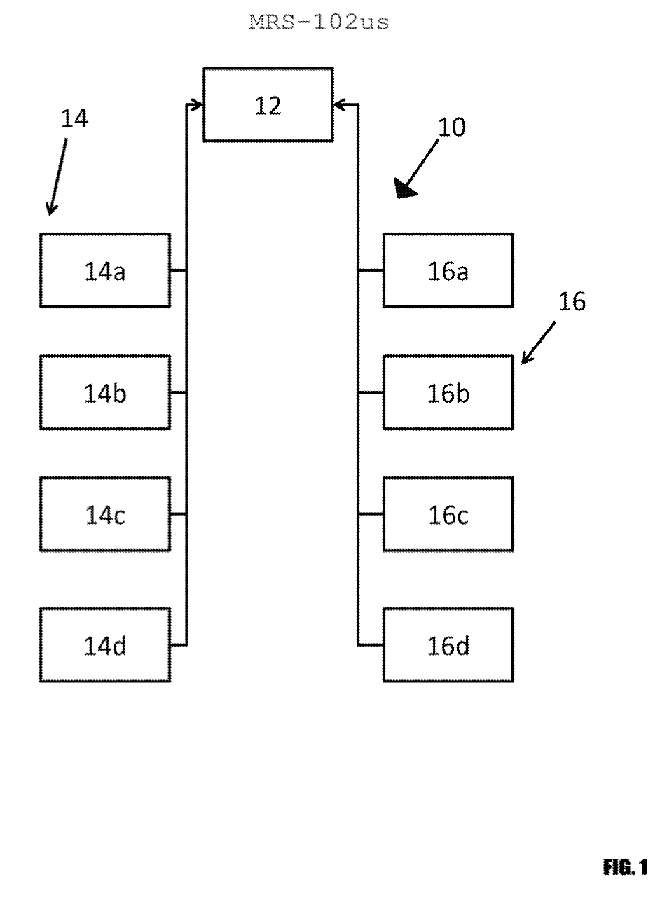

Referring to FIG. 1, a loyalty point collection and distribution social network system 10 is provided to interconnect individuals with merchants that issue loyalty reward points so that the individuals are motivated to purchase merchandise from these merchants and create social networks of others who also purchase from these merchants. The loyalty point collection and distribution social network system 10 includes a social network server 12, interconnected with a plurality of social networks 14, including any number such as 14a, 14b, 14c and 14d (14a-14d) and a plurality of merchants 16 including any number such as 16a, 16b, 16c and 16d (16a-16d).

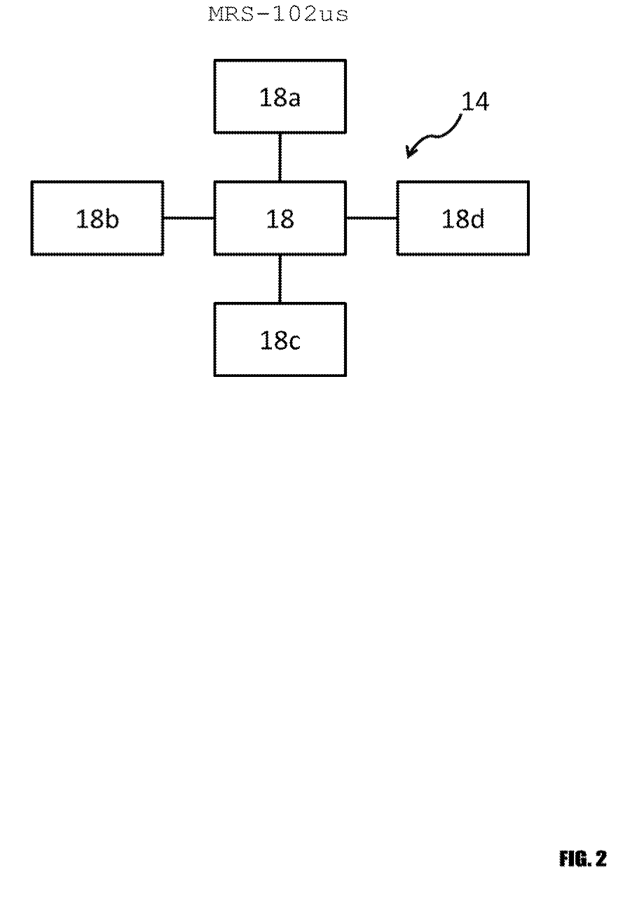

Referring to FIG. 2, each of the social networks is 14 is created by one individual 18 of any number of other individuals 18a, 18b, 18c, and 18d (18a-18d) in the network (network individuals). While four network individuals 18a-18d are described as forming the social network 14, any number of individuals can be included as described in more detail below.

The loyalty point collection and distribution social network system 10, enables the individual 18 to set up a social network 14 of network individuals 18a-18d whereby loyalty or incentive reward points obtained by the individual 18 are shared by the network individuals 18a-18d in the social network.

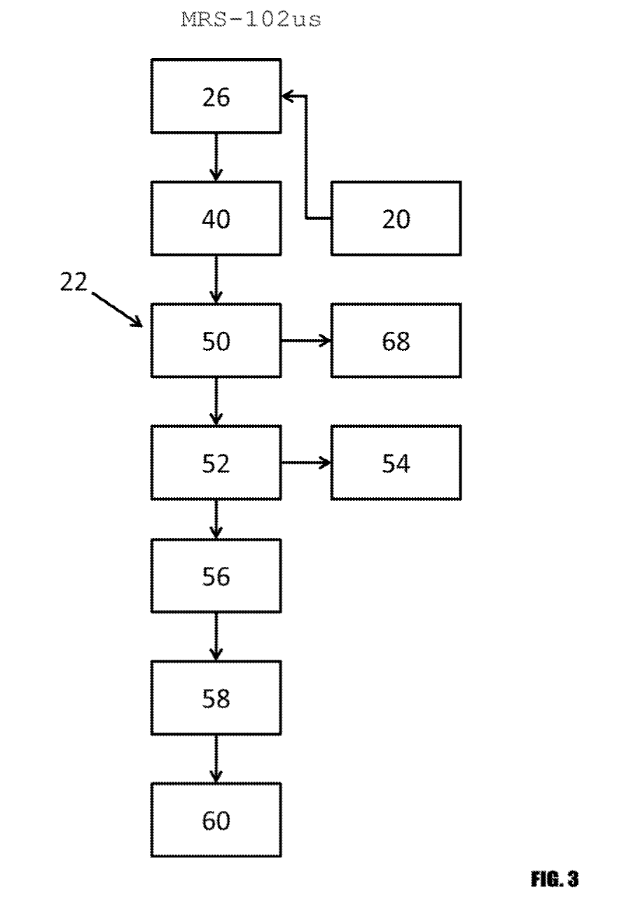

Both the individual 18 and the network individuals 18a-18d forming the social network 14 use a social networking point loyalty application software 20 (hereafter “loyalty application”) as seen in FIG. 3, with their smart phones or other mobile communications devices to purchase items from the merchants 16 and collect loyalty points by participating in the merchants' individual loyalty program. The loyalty application 20 operates as a mobile application for smartphones and tablet devices and is installed into the smartphones or other mobile communications devices of each individual, i.e., any individual in social networks 14a-14d, that is a part of the loyalty point collection and distribution social network system 10.

Each of the merchants 16a-16d uses a merchant social networking point loyalty application software (app) 22 (hereafter “merchant loyalty application”) to identify the individuals 18 and 18a-18d forming the social networks 14a-14d and upload the loyalty points based on the sale at a POS (point of sale) to the individual's social network account on the social network server 12.

The loyalty point collection and distribution social network system 10 is designed as a social network platform that functions as a combination social network and loyalty point distribution system to distribute loyalty points to the individuals 18 and 18a-18d forming the social networks 14a-14d. In general terms, the loyalty application 20 operates when an individual 18 who has created a social network 14 makes a payment at the point of sale of a merchant 16a-16d. The individual 18 is identified at the POS by the merchant loyalty application 22, the loyalty points are uploaded to the social network server 12 and allocated to the individual's social network account based on the sale. The allocated points in the individual's social network account are divided by the server 12 and then split between the individual 18 and the network individuals 18a-18d in the social network 14 that the individual 18 has established.

Initially, an individual 18, who is the user of the loyalty application 20, downloads the loyalty application 20 onto his or her mobile communications device. The mobile communications devices can be a cell phone, smartphone, computer, PDA, or other mobile communications device capable of sending and receiving data over a wireless network. The mobile communications device allows the individual 18 to interact with the social network server 12. Each mobile communications device may include a processor, network interface circuitry, and memory. The loyalty application 20 operates on a mobile software platform such as iPhone OS, Android OS, Palm Web OS, J2ME, Windows Mobile, Flash, Flash Mobile, or other similar mobile software platform. The individual mobile communications device is connected to a wireless network, such as a commercial cellular data network, WiFi, or a WAN network. The operation of these various communication networks are well known and will not be described in greater detail.

After downloading the loyalty application 20, the individual 18 creates an account on the social network server 12 including information such as contact information, and credit card information, and shipping instructions. While the individual 18 typically creates the account on the social network server 12 through their mobile communications device, it is also within the preferred embodiment to create an account directly on the social network server 12 through a website associated with the a loyalty point collection and distribution social network system 10. The website provides a portal to each individual to review their network of individuals, the accumulated points for each merchant and the source of the points, e.g. from which individual in the network and the points of each individual in their network. The website portal also provides access to the merchants who can create a customized web portal for the business to offer customized marketing campaigns, offer various deals on their products and access to their merchandise or services so that individuals can purchase directly from the website portal.

Upon downloading the loyalty application 20, the individual 18 is able to complete a purchase at a POS venue 24, and receive loyalty points for his/her purchase. As a means of identifying the individual 18, it is within the terms of the embodiment that the individual is issued a unique QR code containing personal, network, and payment information by the social network server 12 in the loyalty point collection and distribution social network system 10. In this embodiment, the POS venue 24 will have a QR scanner for identifying the individual 18. However, any means of identifying the individual 18 may be used.

The POS venue 24 processes the purchase made by the individual 18, and determines the loyalty points accrued through the loyalty award programs within the merchant loyalty application 22. The individual POS venues 24 must sign up to be included as vendors that participate in the loyalty point collection and distribution social network system 10 that includes the loyalty application 20. Preferably, the POS venues 24 that participate in the loyalty point collection and distribution social network system 10 use a merchant loyalty application 22 designed specifically for the POS venues. The merchant loyalty application 22 is configured to provide such functionality so as to allow the merchant to create a customized web portal for the business, create a profile, offer customized marketing campaigns, provide statistical data on individuals, and any other desired functions. An important advantage of the loyalty point collection and distribution social network system 10 to the merchants 16 is that each individual 18 acts as a passive promoter for the POS venue 24, since their activity at the POS venue is broadcast to everyone on their social network 14, as described below.

Each POS venue 24 distributes loyalty points to the individual 18 and the network individuals 18a-18d within the social network 14. Each individual POS venue 24 sets the value of the loyalty points, as well as any other promotions or coupons that they wish to offer the individual 18 and those within the social network 14. The advantages of the loyalty point collection and distribution social network system 10 to the merchants 16 include an instant loyalty program, viral exposure, free mobile marketing, and data metrics. Upon purchasing an item at the POS venue 24, information related to the transaction with the individual 18 is encoded by the POS venue with the merchant loyalty application 22. This information relating to the sale, such as the item purchased, the cost of the item, the date and time of purchase, the reward point value associated with the item, and any other relevant information can be stored in the merchant loyalty application 22. Reward points generated by a sale to an individual in the loyalty point collection and distribution social network system 10 are processed by the merchant loyalty application 22 at the POS venue 24 and then transmitted to the social network server 12 to be associated with the individual's social network account.

The social network server 12 is a network-connected server computer system or set of computer systems that provides various types of social network services common to conventional social networks and is interconnected to all of the social networks 14a-14d established by the users 18 of the loyalty application 20. The social network server 12 can be hosted by a web server or server farm, and it offers web portal access for both the POS venues 24 of each of the participating merchants of businesses 16 and for the individuals 18 who create individual social network accounts on the loyalty point collection and distribution social network system 12.

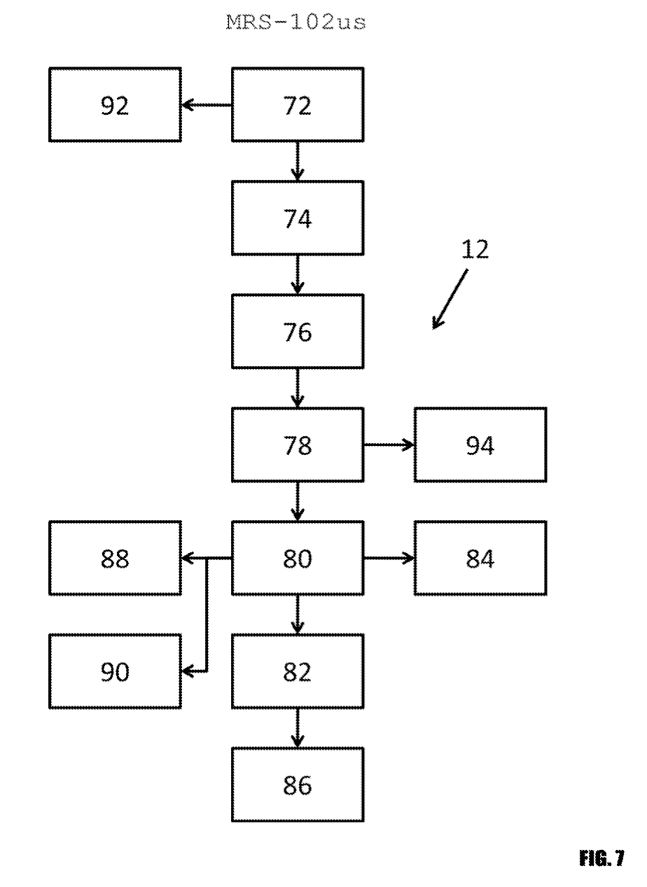

A description of the operation of social network server 12 with reference to FIG. 7 is provided hereinafter.

It is within the terms of the embodiment that the social network server 12 provides a backend tool for each of the participating businesses 16 to create marketing campaigns that communicate, e.g., messages, coupons, and invitations for an event to a individual's friends using the individual's social network account. Further, it is within the terms of the embodiment that the individual 18 may view their accumulated loyalty points on their mobile communications device to a particular POS venue 24, patronage statistics per location, leader boards, as well as their ranking within each location of the participating businesses.

The social network 14 is established by the individual 18. The social network 14 is an online platform in the loyalty point collection and distribution social network system 10 in which the individual 18 may create a social network account, and through which the individual may add “friends,” and share information. The term “friend” refers to another user, also called a network individual 18a-18d herein, with whom the individual 18 has an established link or association in the social network 14. When establishing the social network, the individual 18 may create different tiers of friends, such as family, friends, colleagues, and acquaintances. Each tier of friends or contacts can be assigned a customized level of privacy. For example, a user 18 of the social network service might configure the privacy setting on his or her profile such that a family member can access certain content that the user has posted but acquaintances and colleagues cannot access this content. Alternatively, the user 18 can set the system so as to share loyalty points from certain venders with specific tiers of friends. With the social network 14, the individual 18 can send a request to other individuals 18a-18d to add them as friends, and if these other individuals accept the invitation from individual 18, a link between the profile of the individual 18 and the individuals 18a-18d is established to form a social network 14 centered around individual 18.

The loyalty point collection and distribution social network system 10 can be set up so that linking to another social network, i.e. social network 14a to 14b can provide various benefits to the linked social networks, such as access to content that is only available to other users who are linked to one another and the ability to send private messages to one another.

Further, each user strives to build their own social network 14. As illustrated, individual 18 has a social network of individuals 18a-18d. The advantage to having a large social network 14 is that the user 18 will potentially receive loyalty points from a larger array of POS venues, such as POS venue 24. It is within the terms of the present embodiment that the network individuals 18a-18d give/take reward point ratio is displayed, to provide a greater incentive to be regarded as an “active individual” at the POS venues, making them a more appealing friend for the individual's social network.

The loyalty point collection and distribution social network system 10 is configured and arranged to communicate with each other using means of secure communication that adheres to the rules of each social network when submitting/querying data. The social network systems with which loyalty application 20 may affiliate with include, for example, Twitter, Facebook, and Four Square. The platform of application 20 may of course be configured to integrate with these other, additional social networks in the same or similar fashion. The loyalty point collection and distribution social network system 10 is configured and arranged to communicate with the various other social network systems using means of secure communication, and it adheres to the rules of each social network when submitting/querying data.

As described below, the reward points earned can be allocated, for example, with half for the individual 18 and the other half of the loyalty points are distributed evenly among the network individuals 18a-18d in the individual's social network 14. For example, if the individual 18 earns eight reward points from a purchase at a POS venue 24, he will receive four points and the other four points will be evenly distributed throughout his network of individuals 18a-18d, each receiving one point, respectively. Also by way of example, should individual 18 earn sixteen loyalty points, he will receive eight points and the other eight points will be evenly distributed throughout his network of individuals 18a-18d within social network 14 with individuals 18a-18d, each receiving two points, respectively.

It is within the terms of the embodiment that the individuals within a social group trade points amongst each other. For example, individual 18 could trade 10 points from a first POS venue 24 to individual 18a for 5 points at a second POS Venue. The individuals making the trade could communicate this trade via a messenger system within the social network 14. The loyalty point collection and distribution social network system 10 may be adapted to facilitate these trades and associate the loyalty points with the appropriate individual. It is also within the terms of the embodiment that there be a “trading post” with the various social networks 14a-14d hosted by the loyalty point collection and distribution social network system 10, wherein various individuals who don't know each other or are in different social networks 14 could offer their points, and those individuals interested can offer potential trades.

Once the loyalty points are earned, they may be redeemed at the various participating

POS venues, such as POS venue 24. Each merchant 16 may determine the promotions they want to offer, as well as the reward point value of the promotion. For example, every $1.00 that the individual 18 spends may equal two reward points. Then, ten reward points could equal 25% reduced from the next purchase at POS venue 24. This 25% discount may be redeemed by the individual 18 identifying himself, utilizing loyalty application 20.

In a preferred embodiment, an individual can convert their points to a coupon representing a promotional offer by a merchant. This coupon can be taken to a store and redemmed for the promotional offer, traded or given to anyone in their social network or posted at the “trading post” to trade with someone on another of the social networks 14a-14d hosted by the loyalty point collection and distribution social network system 10,

FIG. 3 is a flow chart illustrating the process in which the loyalty point collection and distribution social network system 10 coordinates the interrelationship between the individual's social network 14 and the POS venue 24.

In step 26, the individual 18 downloads the loyalty application 20 onto a mobile communications device and sets up a social network account within the distribution social network 10. As soon as the individual 18 has downloaded the loyalty application 20, he can begin establishing a social network 14 of network individuals 18a-18d. The loyalty point collection and distribution social network system 10 is setup so that the individual 18 is encouraged to establish as large a social network 14 as possible. However, the loyalty point collection and distribution social network system 10 is still operational if the individual 18 has no other friends in his or her social network 14, such as at the time when the individual 18 initially joins the loyalty point collection and distribution social network system 10.

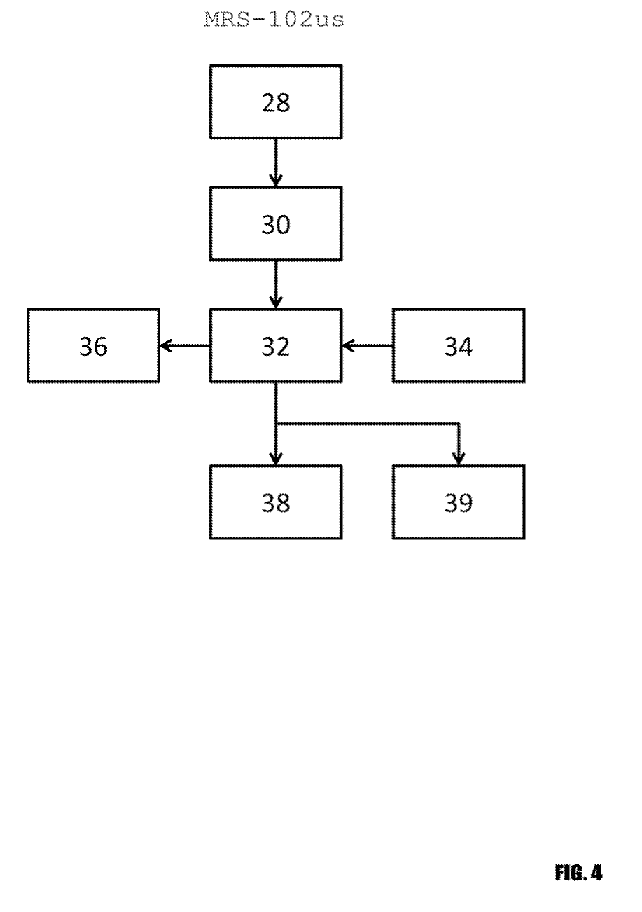

FIG. 4 illustrates the details of accomplishing step 26 shown in FIG. 3 which may used in downloading the loyalty application 20 and creating a social network account with the loyalty point collection and distribution social network system 10. First, in step 28, the individual 18 downloads the loyalty application 20 to a mobile communications device 30, which may include a cell phone, a smartphone, a tablet computer, a PDA, and/or any other portable computing device. Next, in step 32, the individual 18 may create a social network account with a personal profile on the loyalty point collection and distribution social network system 10 by interconnecting with the network server 12 by any means such as across the internet. In step 34, individual 18 has the option to upload multimedia content, such as photos, audio, and/or video content. In step 36, the individual 18 has the option to register their credit card to their social network account on the loyalty point collection and distribution social network system 10. With a credit card on file, any credit card payment at a POS venue 24 will be uploaded to the social network server 12 of the loyalty point collection and distribution social network system 10 and the appropriate amount of loyalty points attributed to the individual 18 and the others in their social network 14.

Next, in step 38, after the individual has downloaded the loyalty application 20 and created a social network account with the loyalty point collection and distribution social network system 10, the individual 18 may invite others to become his “friends” on the social network 14, such as 18a-18d, as described with reference to FIG. 2.

It within the terms of the embodiment that in step 39, the social network server 12 determines if the individual has affiliated itself with an alternative social network systems, such as Twitter, Facebook, and FourSquare. Assuming all listed social network systems are enabled, a corresponding posting is made to Twitter, Facebook, and all other social network systems. For example, a Facebook message or “Tweet” on Twitter could express that individual 18 received five loyalty points at POS venue 24.

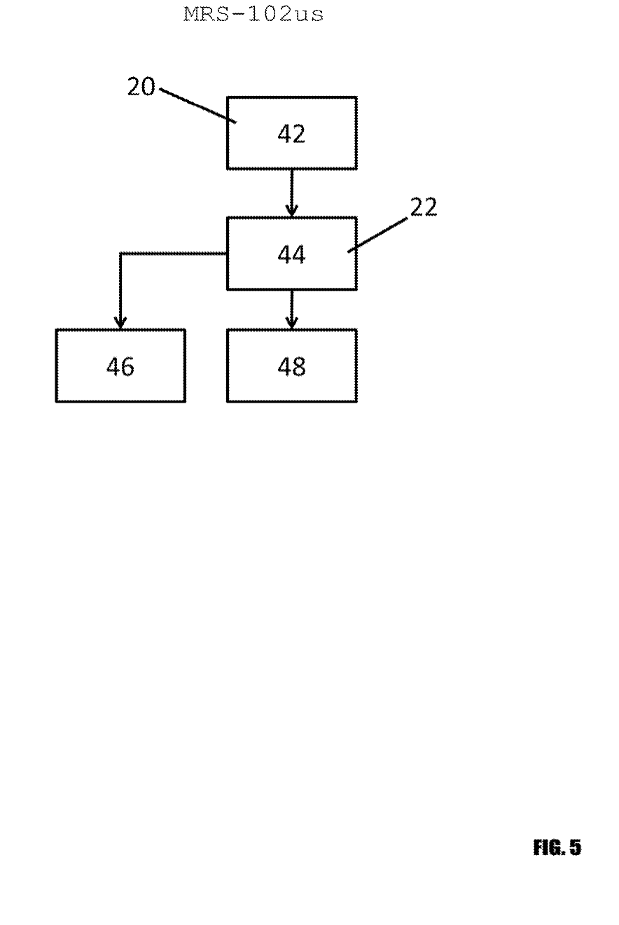

Referring again to FIG. 3, in step 40, the individual 18 makes a purchase and payment at a POS venue 24. The details of the purchase and payment at the POS venue 24 are shown in FIG. 5, which describes a variety of ways that the purchase may be completed. First, in step 42, the loyalty application 20 is accessed on the mobile communications device, such as by identifying himself with a unique QR code, which may be displayed on his individual mobile communications device. As discussed earlier, the unique QR code can contain personal, network, and payment information. Then in step 44, the individual 18 is identified by the POS venue 24 with the merchant loyalty application 22. Then, in step 46, the individual may pay with cash, credit or debit card, via a bank account accessible on the individual's mobile communications device, money that had been added to the social network account, or any other suitable method. Alternatively, in step 48, the individual 18 makes the purchase with a credit card that had been registered with their loyalty application 20. Using a credit card on file, any credit card payment at an associated POS venue 24 will automatically attribute the loyalty points to the individual's social network account without the need for utilizing their mobile communications device and QR code.

Referring to FIG. 3, in step 50, the POS venue 24 identifies the individual 18 as a user of the loyalty application 20. The POS venue 24 has a merchant loyalty application 22, which typically incorporates a QR code scanner to identify the individual 18. As discussed earlier, information related to the individual's transaction with the merchant is encoded with the merchant loyalty application 22. Information relating to the sale, such as the item purchased, the cost of the item, the date and time of purchase, the reward point value associated with the item, and any other relevant information is stored into the merchant loyalty application 22.

Then, in step 52, information relating to the transaction including the individual's unique identifier along with the individual's current accumulated bonus points, business location, and any other relevant information is sent to the social network server 12.

In step 54, the merchant loyalty application 22 determines if the POS venue 24 has affiliated itself with an alternative social network system, such as Twitter, Facebook, and FourSquare. If so, the POS venue 24 may send a “tweet” on Twitter, a message posting on Facebook, or a FourSquare check-in on behalf of a individual upon completion of a transaction.

In step 56, the earned loyalty points corresponding to the payment are allocated by the social network server 12 into the social network 14, to be distributed to the individual and his friends.

In step 58, the earned loyalty points are divided between the individual and his friends within the social network 14.

In step 60, the individual and his friends within social network 14 are notified that they have received loyalty points. The loyalty application 20 on each of the members of the social networks mobile communications devices can give a summary of the amount of points received, who they came from, from which merchant 16, and any other relevant information.

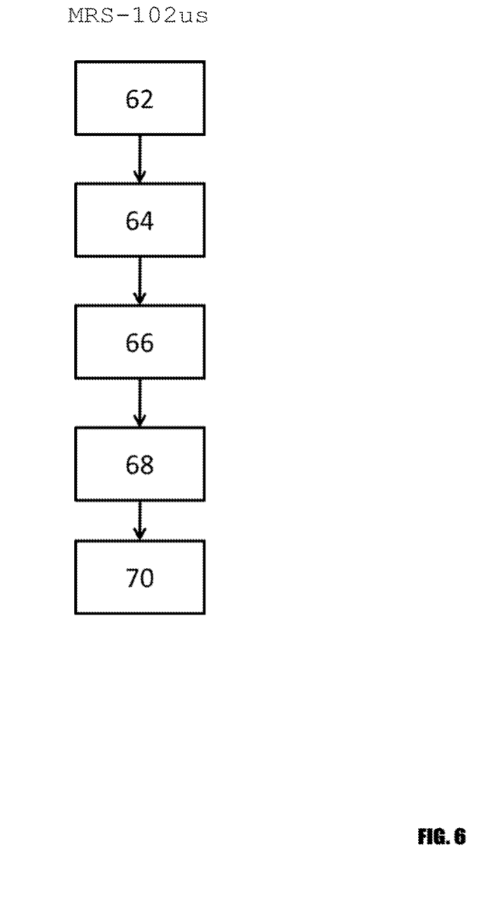

Referring to FIG. 6, there is shown the steps by which the individual utilizes the loyalty points. In step 62, the individual redeems his loyalty points displayed on the loyalty application 20, such as 10% off the purchase at the POS venue 24. In step 64, the loyalty application 20 signals the social network server 12 of the redemption. Then, in step 66, the social network server 12 generates a new QR code that is uploaded to the individual's mobile communications device. In step 68, the POS venue 14 opens its merchant loyalty application 24, inputs the cost of the purchase and reads the new QR code with its scanner. Then, in step 70, the discount is removed from the purchase, and the corresponding loyalty points are removed from the individual's social network account.

Referring to FIG. 7, there is a flow chart showing the operation of the social network server 12.

Initially, in step 72, after an individual has downloaded the loyalty application 20 onto his or her mobile communications device, mobile communications device interconnects with the social network server and creates a social network account on the social network server. The social network account can include a personal profile which may include multimedia content, such as photos, audio, and/or video content. In addition, the personal profile can include a credit or debit card as well as bank information.

In step 74, a social network can be established with other network individuals who have downloaded the loyalty application onto their mobile communications device and interconnect with the social network server 12 to set up social network accounts, similar to the personal profile that are linked to the individual's social network account to form a social network with the individual's social network account.

In step 76, merchants who have downloaded the merchant loyalty application onto their network system at a POS venue, register with the loyalty point collection and distribution social network system by interconnecting with the social network server and creating a social network merchant account.

In step 78, after the individual makes a purchase and payment at a POS venue and the individual is identified by the POS venue with the merchant loyalty application, the information relating to the transaction including the individual's unique identifier along with the loyalty points earned through the purchase, the individual's current accumulated bonus points, business location, and any other relevant information is sent to the social network server and associated with the individual's social network account.

In step 80, the earned loyalty points corresponding to the payment are allocated by the social network server into the individual's social network are distributed to the individual and the network individuals in the individual's social network and split up as previously described.

In step 82, the individual and his friends within social network are notified by the social system server that they have received loyalty points. Preferably, the notification is on the social networks mobile communications devices and can include a summary of the amount of points received, who they came from, from which merchant, and any other relevant information.

In step 84, the notification to the individual and his friends within social network that they have received loyalty points as well as all information relating to the loyalty point collection and distribution social network system is also posted on a website that can be available selectively to those in the system.

In step 86, after the individual utilizes redeems his loyalty points displayed on the loyalty application, the loyalty application signals the social network server of the redemption and the social network server adjusts the individual's social network account and generates a new QR code, corresponding to the number of loyalty points that have been redeemed, that is uploaded to the individual's mobile communications device.

In step 88, the social network server enables individuals within a social group trading loyalty points amongst each other.

In step 90, the social network server enables the individual to trade loyalty points amongst network individuals that are within other social networks.

In step 92, the social network server determines if the individual has affiliated itself with an alternative social network system. The loyalty point collection and distribution social network system 10 is configured and arranged to communicate with the various other social network systems using means of secure communication, and it adheres to the rules of each social network when submitting/querying data.

In step 94, the social network server can link to a customized web portal for a merchant and allow any individual's with accounts on the social network server to access these web portals which can function, for example to offer customized marketing campaigns.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

In the claims:

1. A loyalty point collection and distribution social network system, comprising:
means for forming at least one social network of an individual and one or more other network individuals;
means for identifying the individual during a purchase at at least one POS (point of sale) venue;
means for determining the number of loyalty points earned by the individual at the POS venue from the purchase at the at least one POS venue;
means for inputting the number of loyalty points earned by the individual at the POS venue into a social network server;
means for associating the earned loyalty points from the POS venue with a social network account of the individual; and
means for allocating the earned loyalty points between the individual's social network account and social network accounts of the one or more other network individuals within the social network.

2. The loyalty point collection and distribution social network system of claim 1 wherein the individual and the one or more other network individuals on the at least one social network each has a loyalty application on a mobile communications device capable of sending and receiving data over a wireless network and creating a social network account within the social network server.

3. The loyalty point collection and distribution social network system of claim 2 wherein the at least one POS venue has a merchant loyalty application for identifying the individual, determining the number of loyalty points earned by the individual at the POS venue from the purchase at the POS venue, and sending the number of loyalty points earned by the individual at the POS venue to the social network server for associating the earned loyalty points from the POS venue with the social network account of the individual.

4. The loyalty point collection and distribution social network system of claim 3 wherein the means for identifying the individual is a unique QR code created by the social network server and displayed on the mobile communications device.

5. The loyalty point collection and distribution social network system of claim 4 further including a QR scanner at the POS venue to read the unique QR code of the individual displayed on the mobile communications device.

6. A method of collecting loyalty points and distributing them in a social network, comprising:
forming at least one social network of an individual and one or more other network individuals;
identifying the individual during a purchase by the individual at the at least one POS (point of sale) venue;
determining the number of loyalty points earned by the individual at the POS venue from the purchase at the at least one POS venue;
inputting the number of loyalty points earned by the individual at the POS venue into a social network server;
associating the earned loyalty points from the POS venue with a social network account of the individual; and
allocating the earned loyalty points between the individual's social network account and social network accounts of the one or more other network individuals within the social network.

7. The method of claim 6 including creating a social network account within the social network server for the individual and the one or more other network individuals.

8. The method of claim 7 including providing a loyalty application on the mobile communications device of the individual and on a mobile communications device of each of the one or more other network individuals on the at least one social network.

9. The method of claim 8 including providing a merchant loyalty application at the at least one POS venue for identifying the individual, determining the number of loyalty points earned by the individual at the POS venue from the purchase at the POS venue, and sending the number of loyalty points earned by the individual at the POS venue to the social network server for associating the earned loyalty points from the POS venue with the social network account of the individual.

10. The method of claim 9 including creating a unique QR code with the social network server for the individual and each of the one or more other network individuals.

11. The method of claim 10 including displaying the unique QR code on the loyalty application downloaded to the mobile communications device of the individual and each of the one or more other network individuals.

12. The method of claim 11 including reading the unique QR code of the individual displayed on the mobile communications device at the POS venue.

13. The method of claim 12 further including;
registering the POS venue on the social network server to be included as a vendor that participates in the collection and distribution of loyalty points collection.

14. The method of claim 13 including storing the number of loyalty points earned from a purchase by the individual on the merchant loyalty application at the POS venue.

15. The method of claim 14 including trading loyalty points between the individual and the other network individuals within the individual's social network.

16. The method of claim 15 including trading loyalty points among individuals and network individuals of other social networks.

17. The method of claim 16 further including configuring and arranging the loyalty point collection and distribution social network system to communicate with other social network systems using means of secure communication, and adhering to the rules of each social network when submitting/querying data.

18. The method of claim 17 including:
redeeming loyalty points on the loyalty application; and
inputting the number of redeemed loyalty points into the individual's social network account on the social network server.

19. The method of claim 18 including generating a new QR code to be displayed on the individual's mobile communications device based on the number of loyalty points in the individual's social network account.

20. The method of claim 19 including:
opening the merchant loyalty application at the POS venue;
reading the individual's new QR code; and
removing a discount corresponding to the number of redeemed loyalty points from a purchase using the loyalty points.
